(19) United States
(12) Patent Application Publication
(10) Pub. No.: US 2012/0131430 A1
(43) Pub. Date: May 24, 2012

(54) MULTIMEDIA BOOKMARK METHOD AND SYSTEM THEREOF

(75) Inventors: D.J. CHEN, HSINCHU CITY (TW); CHEN-YU LEE, TAIPEI CITY (TW); LIANG-HSIAO CHAO, TAIPEI CITY (TW); SANG-HUE YEN, TAIPEI CITY (TW); CHIA-HUNG HSIAO, TAICHUNG CITY (TW); CHIEN-CHAO TSENG, HSINCHU CITY (TW); TI CHUANG CHIANG, TAIPEI CITY (TW)

(73) Assignee: NATIONAL CHIAO TUNG UNIVERSITY, HSINCHU CITY (TW)

(21) Appl. No.: 13/085,610

(22) Filed: Apr. 13, 2011

(30) Foreign Application Priority Data
Nov. 23, 2010 (TW) 099140468

(51) Int. Cl. G06F 17/21

(52) U.S. Cl. 715/206

(57) ABSTRACT

The present invention discloses a multimedia bookmark method and a system thereof. The method of the present invention comprises steps: providing a plurality of digital annotations for an information object; creating a bookmark containing an ordered set organized according to a time relativity, a file relativity or a user-defined attribute of the digital annotations; and presenting the bookmark and the information object corresponding to the bookmark. Thereby, the present invention provides complete, meaningful and multi-aspect bookmarks, enabling users to easily understand and conveniently use the annotations.

### BACKGROUND OF THE INVENTION

1. Field of the Invention

The present invention relates to a multimedia bookmark method and a system thereof, which establish relativities of annotations and present the ordered sets of the annotations.

2. Description of the Related Art

Students or readers are usually overburdened with books for diversified and long-time learning or reading, especially during tour. With arrival of newsonomics, the digital content market flourishes more and more and encourages fast development of E-book technologies, such as those disclosed in U.S. Pat. Nos. 5,739,814, 5,761,485, 5,761,681 and 5,80,251. Recently, E-book products have gradually replaced traditional books. Normally, the content can be annotated in an E-book. For example, the content of an E-book can be commented with words, marked with colors, linked to websites, or attached to by files to function as study notes and facilitate review.

However, the abovementioned are all static annotations. Further, the annotations are added randomly and independent to each other. Furthermore, the annotations are usually incomplete and lack clear relationship with the contents and unable to facilitate efficient learning or reading. Therefore, how to organize the annotations into a complete and meaningful study notes is a problem the field desires to solve.

Accordingly, the present invention proposes a multimedia bookmark method and a system thereof to overcome the abovementioned problems.

### SUMMARY OF THE INVENTION

The primary objective of the present invention is to provide a multimedia bookmark method and a system thereof, which establish the relativities of annotations and arranges the presentation sequence of the annotations to enable the user to easily understand the meanings of the annotations and encourage the user to undertake dynamic thinking, whereby is promoted the learning interest and study efficiency of the user.

Another objective of the present invention is to provide a multimedia bookmark method and a system thereof, which apply to E-books, medical information systems, digital instruction systems, multimedia networks, etc.

To achieve the abovementioned objectives, the present invention proposes a multimedia bookmark method, which comprises steps: providing a plurality of digital annotations for an information object; creating a bookmark containing an ordered set organized according to a time relativity, a file relativity or a user-defined attribute of the digital annotations; presenting the bookmark and the information object corresponding to the bookmark.

The present invention also proposes a multimedia bookmark system, which comprises an edition module providing a plurality of digital annotations for an information object, creating a bookmark containing an ordered set organized according to a time relativity, a file relativity or a user-defined attribute of the digital annotations to enable the bookmark function as a complete and meaningful study note of the information object; a display module electrically connected with the edition module and presenting the bookmark and the information object corresponding to the bookmark; and a processing module electrically connected with the edition module and the display module and controlling the activities thereof.

Below, the embodiments are described in detail to make easily understood the objectives, technical contents, characteristics and accomplishments of the present invention.

### BRIEF DESCRIPTION OF THE DRAWINGS

FIG. 1 is a block diagram schematically showing the architecture of a multimedia bookmark system according to one embodiment of the present invention;

FIG. 2 is a flowchart of a multimedia bookmark method according to one embodiment of the present invention;

FIG. 3 shows digital annotation edition according to one embodiment of the present invention;

FIG. 4 shows a presentation sequence of digital annotations according to one embodiment of the present invention; and

FIG. 5 shows another presentation sequence of the same digital annotations in FIG. 4.

### DETAILED DESCRIPTION OF THE INVENTION

With popularization of digital learning, the Ministry of Education of Taiwan has taken digital learning into the focus development programs. Therefore, the present invention proposes a digital bookmark method and system, which applies to E-books, medical information systems, digital instruction systems, multimedia networks, etc., whereby the user can conveniently and arbitrarily add digital annotations containing his own opinions and records when he reads an information object, and whereby the user can use the relativities of the digital annotations and the information object corresponding to the digital annotations to create a complete and meaningful study note. When applied to E-books, the present invention can promote the learning interest and study efficiency of the user and encourage the user to think dynamically. When applied to medical information system, the present invention can help experienced physicians and medical professors to record medical opinions, analyze diseases and make pathological judgments, and provide more complete instruction materials for medical students. When applied to ward information systems, the present invention can record the healthcare knowledge and patients' conditions recited by physicians, whereby patients and their families can conveniently read and learn it repeatedly.

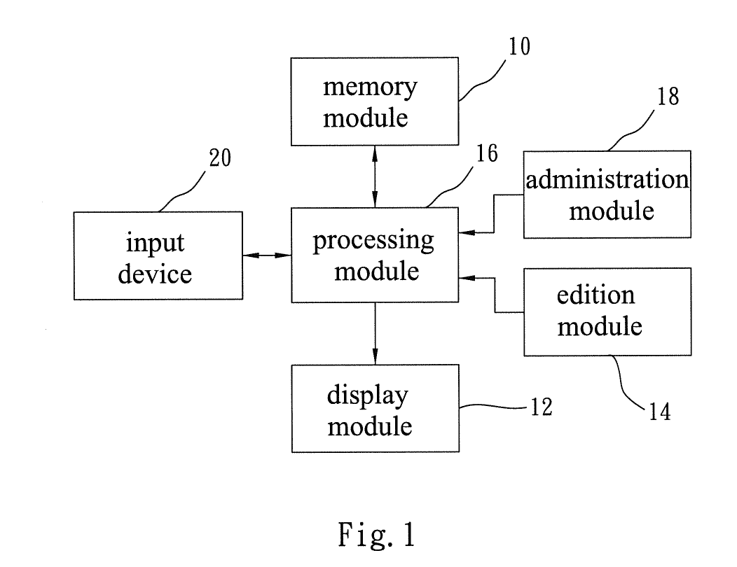

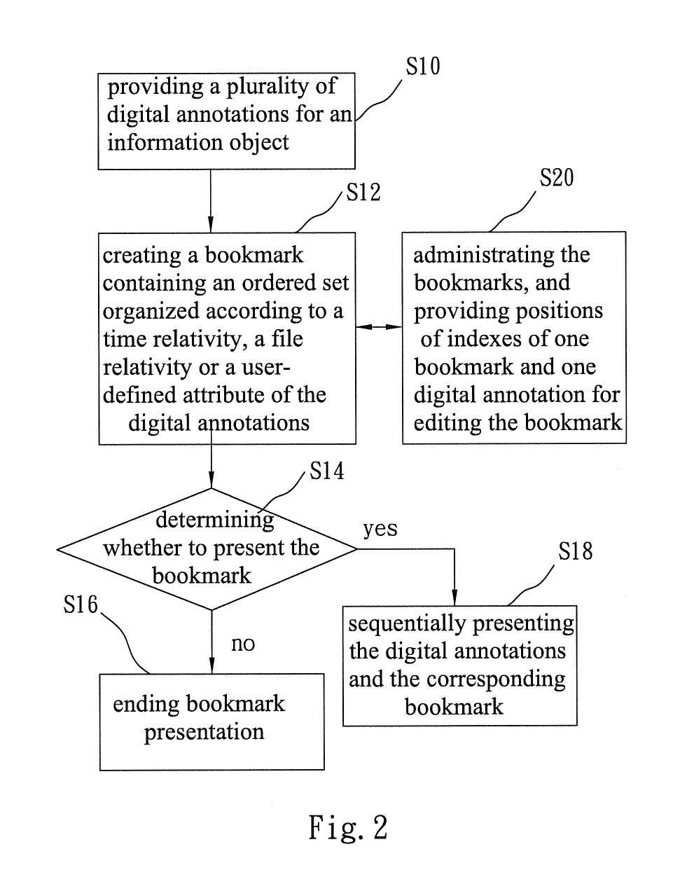

Refer to FIG. 1 and FIG. 2. FIG. 1 is a block diagram schematically showing the architecture of a multimedia bookmark system according to one embodiment of the present invention. FIG. 2 is a flowchart of a multimedia bookmark method according to one embodiment of the present invention. The multimedia bookmark system of the present invention comprises a memory module 10, a display module 12, an edition module 14, a processing module 16, an administration module 18 and an input device 20. The processing module 16 is electrically connected with the memory module 10, the display module 12, the edition module 14, the administration module 18 and the input device 20 and controls the abovementioned modules according to the user's operations. The memory module 10 stores a plurality of information objects and a plurality of annotations. The information object may be a multimedia content, a text content, a webpage or an image. When the user intends to read an information object (such as a text content), the processing module 16 retrieves the information object from the memory module 10 and presents it on the display module 12. In Step S10, the user uses the edition module 14 to supply a plurality of digital annotations to an information object, and the memory module 10 stores the digital annotations. The digital annotations may be in form of text, A/V (audio/video) information, voice, images, multimedia data, URL (Universal Resource Locator), or application links. In Step S12, create a bookmark containing an ordered set organized according to a time relativity, a file relativity, a user-defined relativity of the digital annotations, wherein indexes is established for digital annotations and the corresponding information object. The edition modules 14 can create several bookmarks each containing different ordered sets organized according to different relativities of the digital annotations. Thus, a one-to-multiple relationship exists between the digital annotations and the bookmarks. In Step S14, the processing module 16 determines whether to present the bookmarks. If the answer is “no”, the process proceeds to Step S16, and bookmark presentation is ended. If the answer is “yes”, the process proceeds to Step S18, and digital annotations and the corresponding information objects are presented on the display module 12. According to the positions of the indexes, the digital annotations and the corresponding information objects are sequentially presented on the display module 12 until all the digital annotations have been sequentially presented on the display module 12 one after one. When reading an information object, the user can easily grasp the meaning of the annotations from the relativities and the presentation sequence thereof. Thereby, the present invention can promote the learning interest and study efficiency of the user, and encourage the user to undertake dynamic thinking. In addition to editing the digital annotations in Step S12, the present invention also administrates the bookmarks, which have been organized into ordered sets in Step S12, or edits the digital annotations of the bookmarks, in Step S20. In Step S20, an administration module 18 is used to administrate the bookmarks, including addition, deletion, modification, encryption, decryption, authorization, download, upload, storage, copyright and storage of bookmarks. When intending to edit the digital annotations of the bookmarks, the user uses the administration module 18 to provide the positions of the indexes and then uses the input device 20 to edit the digital annotations.

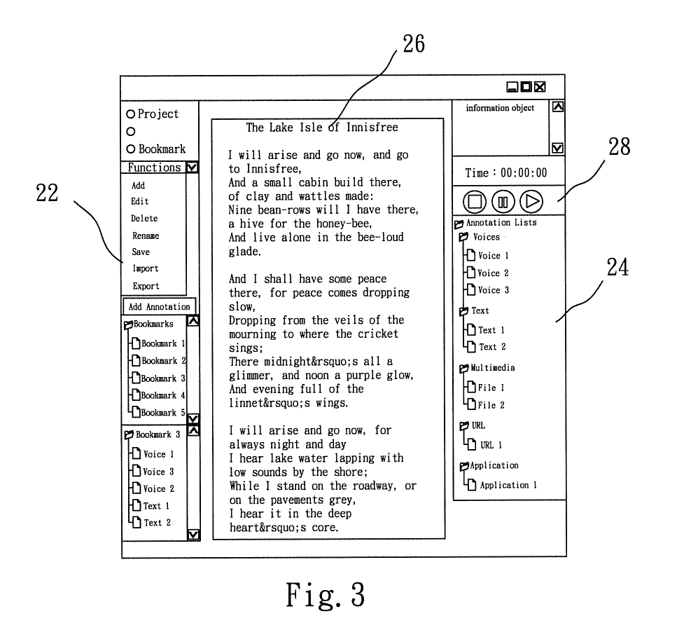

Refer to FIG. 3 for an embodiment of digital annotation edition, wherein the information object is exemplified by a text content. In this embodiment, an annotation edition window 22, an annotation label window 24, an information object window 26 and a display operation window 28 are presented on the display module 12. When intending to add a digital annotation to the current text content, the user uses an input device 20, such as a mouse or a touchscreen, to select an annotation edition mode from the annotation edition window 22. The digital annotation may be in form of text, A/V (Audio/Video) data, voice, images, multimedia data, URL, or application links. The detail thereof will be described later.

If the user selects a voice annotation mode, a microphone is used to pick up voices. Next, the edition module 14 converts the voices into a voice annotation file and assigns a corresponding label to the text content in the information object window 26.

If the user selects a text annotation mode, a keyboard or a voice recognition device is used to receive text information. Next, the edition module 14 converts the text into a text annotation file and assigns a corresponding label to the text content in the information object window 26.

If the user selects a URL annotation mode, the edition module 14 records a webpage linking information and assigns a corresponding label to the text content in the information object window 26.

If the user selects a multimedia annotation mode, the edition module 14 records the route to a multimedia file and assigns a corresponding label to the text content in the information object window 26.

Similarly to the case of the multimedia annotation, if the user selects an A/V annotation mode or an application annotation mode, the edition module 14 records the route to an A/V file or an application program and assigns a corresponding label to the text content in the information object window 26.

The annotation label window 24 lists all the labels existing in the text content of the information object window 26. As shown in FIG. 3, the annotation list has three voice annotations—Voice Annotation 1, Voice Annotation 2 and Voice Annotation 3; two text annotations' such as Text Annotation 1 and Text Annotation 2; two A/V annotations' such as A/V Annotation 1 and A/V Annotation 2; a URL annotation’ such as URL Annotation 1 and an application annotation’ such as Application Annotation 1. The label list does not show the details of annotations but only records the annotation labels and the types thereof.

When the user edits digital annotations, he uses the annotation edition window 22 to assign relativities or attributes to the digital annotations, and the system records the relativities and attributes. If a time relativity is assigned to some digital annotations, these digital annotations are grouped into a time-relativity bookmark containing an ordered set organized according to the time points of edition or the time points of presentation. If a file relativity is assigned to some digital annotations, these digital annotations are grouped into a file-relativity bookmark containing an ordered set organized according to the types, data quantities, formats of the files. If a user-defined relativity is assigned to some digital annotations, these digital annotations are grouped into a user-defined bookmark containing an ordered set organized according to the attribute defined by the user. As shown in FIG. 3, the text content has five bookmarks such as Bookmark 1 to Bookmark 5, which are created via grouping the digital annotations into ordered sets according to different attribute relativities. As each digital annotation has several different attributes, a one-to-multiple relationship exists between each digital annotation and the bookmarks. The digital annotations are presented according to different sequences in different bookmarks respectively having different attribute relativities. Therefore, the information object has several bookmarks respectively organized from different aspects. Thereby, the present invention implements a complete, meaningful and multi-aspect study note and enables different users to easily understand and conveniently use the annotations.

The user can also administrate the bookmarks. When intending to edit the digital annotations of the bookmarks, the user provides the positions of the indexes of the bookmarks and the digital annotations. Next, the user uses the input device 20 to select the annotation edition mode from the annotation edition window 22 to arbitrarily edit the digital annotations. For example, the user can add new digital annotations, delete annotations, or vary the presentation sequence of digital annotations.

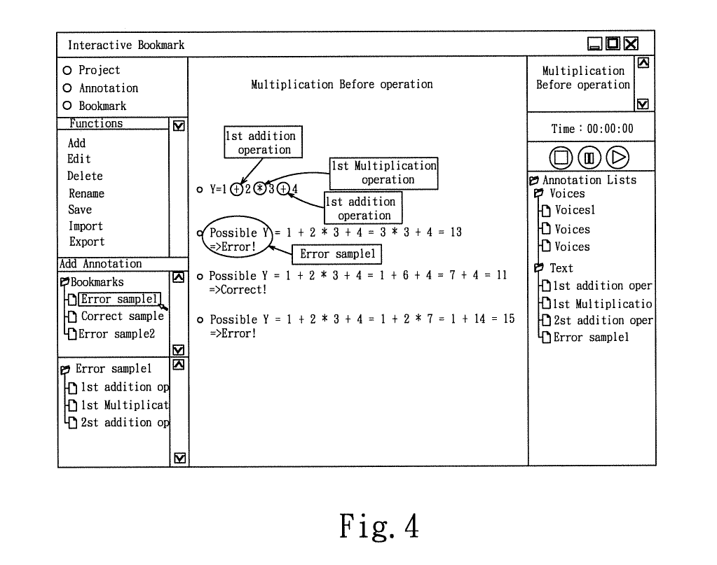

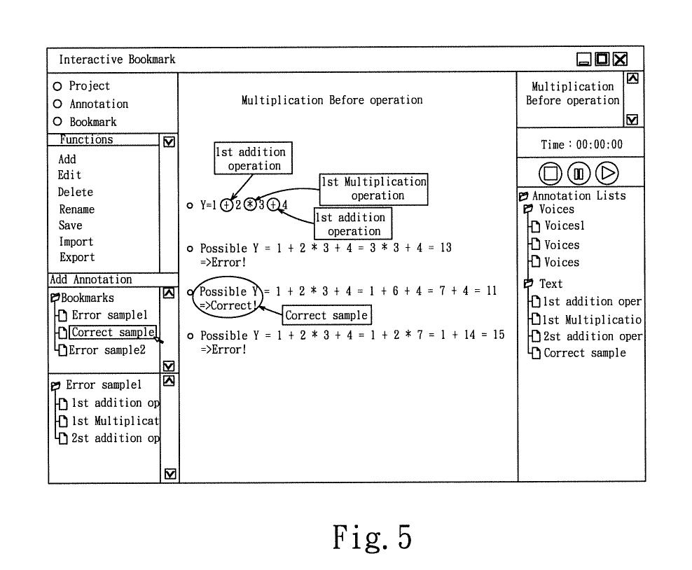

Refer to FIG. 4 and FIG. 5, wherein the information object has three digital annotations. In the information object are created two bookmarks—Error sample 1 and Correct sample 1, which are ordered sets organized according to different attributes of the three digital annotations. The user may use the administration module 24 to vary the presentation sequence of the three digital annotations. As shown in FIG. 4, in the bookmark Error sample 1, the digital annotations are presented in a sequence: 1st addition operation→1st multiplication operation—2nd addition operation. As shown in FIG. 5, in the bookmark Correct sample 1, the digital annotations are presented in a sequence: 1st multiplication operation→1st addition operation→2nd addition operation. Therefore, Error sample 1 and Correct sample 1 respectively have different presentation sequences and thus have diversified instruction effects the conventional annotation systems cannot provide.

Refer to Table.1 for comparison of the present invention and the conventional annotation systems.

TABLE 1

| | The Conventional | The Present |
|---|---|---|
| | Technology | Invention |
| Initialization | by content | by bookmark/digital |
| | | annotation |
| Execution | in a sequence of the items | in a sequence determined by |
| sequence | appearing in the content | one of the attributes of |
| | | annotations |
| Annotation | an annotation can only | an annotation can annotate |
| capability | annotate a single object | several objects |
| Annotation | none relativity existing in | relativities established for |
| relativity | annotations | annotations |
| Performance | statically presenting | dynamically presenting |
| | momentary thinking | thinking and learning |
| | generated in reading the | activities undertaken in |
| | content | reading the content |

In conclusion, the present invention establishes the relativities of annotations and arranges the presentation sequences of the annotations to enable the user to easily understand the meanings of the annotations and encourage the user to think dynamically. Thereby, the present invention can overcome the conventional problem that the annotations are independent to each other and lack a definite relationship with the content. Further, the present invention can promote the learning interest and study efficiency of the user.

The embodiments described above are only to exemplify the present invention but not to limit the scope of the present invention. Any equivalent modification or variation according to the spirit of the present invention is to be also included within the scope of the present invention.

What is claimed is:

1. A multimedia bookmark method comprising steps:
providing a plurality of digital annotations for an information object;
creating a bookmark containing an ordered set organized according to a time relativity, a file relativity, a user-defined attribute of said digital annotations; and
presenting said bookmark and said information object corresponding to said bookmark.

2. The multimedia bookmark method according to claim 1, wherein said bookmarks are respectively created via organizing said digital annotations into an ordered set according to relativities or attributes of said digital annotations to form a one-to-multiple relationship between each said digital annotation and said bookmarks.

3. The multimedia bookmark method according to claim 1, wherein an index is built for each of said digital annotations of said bookmark, and said index is also built for said information object where said digital annotations are established.

4. The multimedia bookmark method according to claim 3 further comprising a step of providing positions of said indexes of one said bookmark and one said digital annotation when a user intends to administrate said bookmark or edit said digital annotation of said bookmark.

5. The multimedia bookmark method according to claim 3, wherein said digital annotations are sequentially presented according to positions of said indexes, and said information object where said digital annotations are established is also presented.

6. The multimedia bookmark method according to claim 1, wherein said time relativity is related with time points of creating said digital annotations or time points of presenting said digital annotations.

7. The multimedia bookmark method according to claim 1, wherein said file relativity is related with file types, file capacities or file formats of said digital annotations.

8. The multimedia bookmark method according to claim 1, wherein said user-defined attribute is related with a bookmark defined by a user.

9. The multimedia bookmark method according to claim 1, wherein said information object contains a multimedia content, a text content, or an image content.

10. The multimedia bookmark method according to claim 1, wherein an input device is used to select an addition mode, a delete mode, an edition mode or a presentation mode of said digital annotations of said information object.

11. A multimedia bookmark system comprising
an edition module providing a plurality of digital annotations for an information object, creating a bookmark containing an ordered set organized according to a time relativity, a file relativity or a user-defined attribute of said digital annotations;
a display module electrically connected with said edition module and presenting said bookmark and said information object corresponding to said bookmark; and
a processing module electrically connected with said edition module and said display module and controlling activities thereof.

12. The multimedia bookmark system according to claim 11, wherein said edition module creates said bookmark via organizing said digital annotations into an ordered set according to one of relativities or attributes of said digital annotations to form a one-to-multiple relationship between each said digital annotation and said bookmarks.

13. The multimedia bookmark system according to claim 11 further comprising an administration module electrically connected with said edition module and said processing module, administrating said bookmarks, and providing positions of indexes of one said bookmark and one said digital annotation for editing said bookmark.

14. The multimedia bookmark system according to claim 13, wherein said digital annotations are sequentially presented according to positions of said indexes, and said information object where said digital annotations are established is also presented.

15. The multimedia bookmark system according to claim 13, wherein said administration module is used to administrate addition, deletion, modification, encryption, decryption, authorization, download, upload, storage, copyright and storage of said bookmark.

16. The multimedia bookmark system according to claim 11, wherein said time relativity is related with time points of creating said digital annotations or time points of presenting said digital annotations.

17. The multimedia bookmark system according to claim 11, wherein said file relativity is related with file types, file capacities or file formats of said digital annotations.

18. The multimedia bookmark system according to claim 11, wherein said user-defined attribute is related with a bookmark defined by a user.

19. The multimedia bookmark system according to claim 11, wherein an input device is used to select an addition mode, a delete mode, an edition mode or a presentation mode of said digital annotations of said information object.
